(19) United States
(12) Patent Application Publication
(10) Pub. No.: US 2004/0074470 A1
(43) Pub. Date: Apr. 22, 2004

(54) Method for powering an engine by combustion of silicon hydrogens and silicon powder with self-generating silicon nitride lubrication

(76) Inventor: Peter Plichta, Dusseldorf (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/433,293

(22) PCT Filed: Nov. 27, 2001
(86) PCT No.: PCT/DE01/04457

(30) Foreign Application Priority Data
Dec. 1, 2000 (DE) 100 59 741.6
Sep. 13, 2001 (DE) 101 45 115.6

(51) Int. Cl. F02B 53/04

(52) U.S. Cl. 123/216; 123/241

(57) ABSTRACT

The invention relates to a method for powering a motor by using a combination of an explosion motor and a turbine. The combustion reaction in said combination occurs by the reaction of a variable mixture consisting of silicon hydrogens, silicon powder in a water solution and air, whereby water and silicon nitride are produced as exhaust gas. The inner wall of the motor should be coated with silicon nitride, which continuously and simultaneously takes place during the combustion process. A sufficient lubricating film consisting of silicon nitride is always is always provided in the fringe area between the inner wall of the motor and the combustion chamber so that no friction occurs. After being expelled from the explosion engine, the excess heat in the combustion gases is mixed with cold, compressed air, which is then used to drive a turbine whose shaft is coupled to the shaft of the explosion engine to enable the latter to run uniformly. By mixing the exhaust gases with cold air, the combustion gases are cooled off so that the silicon nitride can be filtered as solid dust during the end phase and subsequently processed industrially.

By German patent 196 12 07 it is known to burn silicon hydrides with air in a turbine with two combustion chambers. Dispersed silicon powder or dispersed metal suicides are added to the fuel in order to completely burn the nitrogen of the air.

For example, the stoichiometric combustion equation for a heptasilane Si₇H₁₆ mixed with silicon powder with air consisting of 20% oxygen and 80% nitrogen is

16H+40₂→8H₂O (equation 1)

7Si+16N₂+17 dispersed Si→8Si₃N₄ (equation 2)

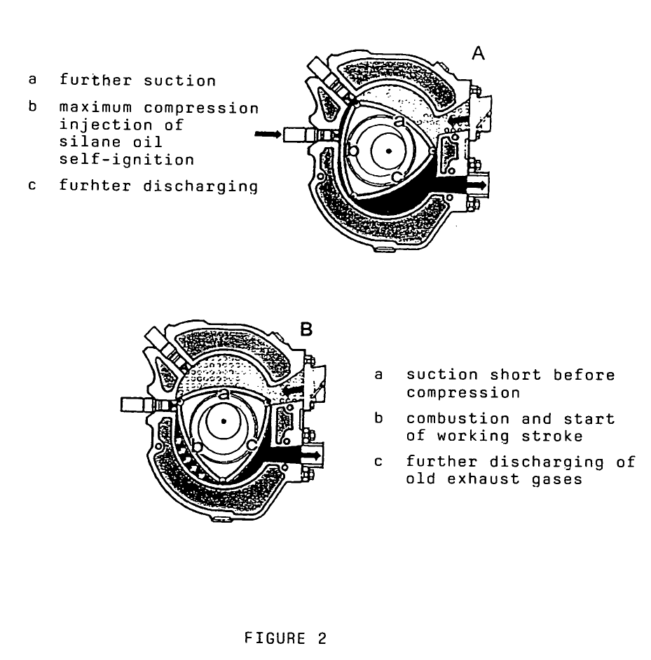

It is the object of the present invention to describe a method, as supplement of German patent 196 12 507, for driving one and the same shaft primarily with an explosion engine and additionally and secondarily through the mechanical rotary forces which are generated in a joined turbine chamber in which the very hot combustion gases from the explosion engine are mixed with cold air sucked from the atmosphere and are cooled in this manner. The dusty silicon nitride generated thereby is captured and subsequently processed for the generation of ammonia, as known from German patent application 100 48 472.7. A mixture of air and not self-igniting higher silane has the characteristic to immediately ignite when compressed. Accordingly, one can desist from an ignition spark in an explosion engine operated with silane. The difference with regard to a conventional Diesel engine consists in the fact that one can desist from the high pressures necessary for igniting a Diesel air mixture. On the other side, the silane Diesel fuel cannot be injected during the compression phase since it ignites with the air untimely. In place of that the silane oil is only injected at the time of the maximum compression of the working space volume with high pressure and ignites instantaneously (see FIGS. 2A, b). Especially, conventional Wankel engines have the additional disadvantage that the working space is insufficiently sealed so that a carbon Diesel operation is practically impossible on account of the necessary high pressures.

When operating with silanes the combusiton temperature within the explosion engine is very high since the nitrogen does not cool the total reaction as inert passive gas, as this is the case with conventional combustion reactions, but acts as an oxidant, i.e. supplies additional combustion heat. Water H₂O and silicon nitride Si₃N₄ are generated as combustion products. Therefore, the inner space of the engine has to be coated with ceramic. However, silicon nitride is used as material for the construction of turbines and engines just on account of its hardness and abrasion resistance and heat resistance up to 1900° C. If the engine parts adjacent to the working spaces are coated with silicon nitride the inner walls of the engine consist of the same substance as the combustion product Si₃N₄ which is continuously generated in the inner space of the engine.

Since the engine parts are cooled from the outside a kind of solid-liquid interface layer is formed on the inner wall of the engine in which the substance silicon nitride is present in different phases at temperatures up to 1900° C. However, since silicon nitride is always present in excess on account of the continuous new generation a mechanical abrasion of the engine walls does not occur. Simultaneously, the interface layer acts as sealant or lubricant.

Since conventional explosion engines work at substantially lower temperatures the efficiency of the described silane explosion engine is substantially higher.

The amount of the injected silane oil is stoichiometrically dependent on the amount of the oxygen from the sucked air since the formation of silicon monoxide is suppressed. Accordingly, the major part of the 80% nitrogen portion of the sucked air is not influenced by the reaction with the silane. In place of that this reacts with additionally introduced silicon powder (see reaction equations 1 and 2).

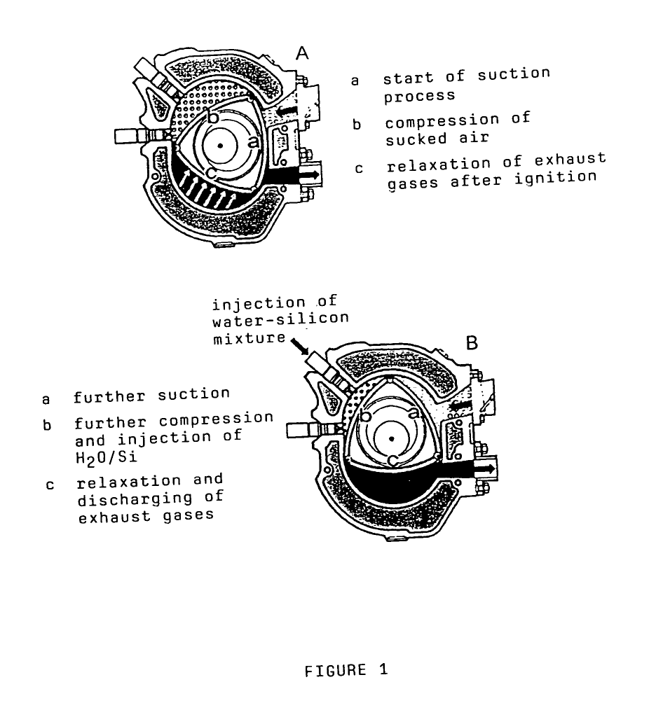

This silicon powder can be either injected as dispersion together with silane or it is already blown in during the compression phase together with air or it is used as dispersion with water (see FIGS. 1B, b). In addition to that additional water can prevent an overheating of the engine and simultaneously does additional work by evaporation.

It has to be taken care that the total amount of silicon is not larger than the total amount of nitrogen in every combustion process since otherwise silicon would remain which might cause abrasion. This is especially important during a cold start phase. The first two operation steps 1 and 2 of the silane Wankel engine are shown in FIG. 1 while the operation steps 3 and 4 are shown in FIG. 2 schematicly. The central triangular rotary piston rotates anticlockwisely therein. The three sides of the rotary piston are characterized by the letters a, b and c and form together with the combustion chamber wall three part-ranges. In these part-ranges sequentially different processes take place during the course of rotation of the rotary piston which are shown in the drawing. After the operation step 4 the combustion cycle is terminated. The next begins again with operation step 1.

The combustion products discharged from the explosion engine have still an enormous temperature. In order to use this energy in the second part of the engine the hot combustion gases are mixed with the multiple amount of compressed cold air. This mixture operates a turbine for the additional generation of energy whose shaft is connected to the shaft of the explosion engine.

Consequently, the silicon nitride cooled in this manner can be subsequently captured or filtered and does not enter into the atmosphere but into an replacable container.

Furthermore, if a Wankel engine is used the coupling of the shaft improves the running characteristic of the same just at small speeds.

1. A method of powering an engine according to which silicon containing fuels, preferably silane oils and powdery silicon, are introduced into a combustion chamber, characterized in that the engine is a self-igniting explosion engine with variable combustion chamber geometry in which, during the combustion of the fuel, always smallest silicon nitrides particles with quasi liquid properties are formed which serve for the lubrication of the combustion chamber walls, wherein the mixture ratio of fuel and oxidant is adjusted such that the generated combustion products are free of silicon oxides.

2. The method according to claim 1, characterized in that the engine parts are coated with silicon nitride Si₃N₄ or totally consist of ceramic, wherein it is achieved in coaction with the combustion product Si₃N₄ always newly generated in the real combustion process that no abrasion occurs on the inner wall of the engine but in contrast always sufficient lubricant as Si₃N₄ in boundary face is present.

3. The method according to claim 1 or 2, characterized in that the silane oil is injected in the moment of highest combustion chamber compression.

4. The method according to claim 1, 2 or 3, characterized in that the silicon powder is already blown in during the compression phase or is introduced into the combusition chamber as aqueous dispersion, wherein the engine is at first water-cooled from the interior and subsequently during the combustion additional lifting work by generated water vapour is done.

5. The method according to one of the preceding claims, characterized in that the working temperature is increased to a value shortly below 1900° C.

6. The method according to claim 1, characterized in that the combustion gases which are still very hot when they are discharged from the explosion engine are mixed with cold compressed air and thus additionally drive a turbine, whereby simultaneously the hot silicon nitride is cooled and can be subsequently captured as dusty powder.

7. The method according to claim 6, characterized in that the shaft driven by the turbine is connected to the shaft driven by the explosion engine, whereby the explosion engine runs more quietly and more effectively on the whole.
